(19) United States
(12) Patent Application Publication
(10) Pub. No.: US 2017/0269505 A1
(43) Pub. Date: Sep. 21, 2017

(54) DEVELOPING DEVICE

(71) Applicant: CANON KABUSHIKI KAISHA, Tokyo (JP)

(72) Inventors: Osamu Ariizumi, Matsudo-shi (JP); Jun Shirayanagi, Ushiku-shi (JP)

(21) Appl. No.: 15/460,317

(22) Filed: Mar. 16, 2017

(30) Foreign Application Priority Data
Mar. 18, 2016 (JP) 2016-054706

(51) Int. Cl. G03G 15/08

(52) U.S. Cl. CPC G03G 15/0877

(57) ABSTRACT

A developing device including a developer carrying sleeve; a first chamber; a second chamber; a partition having a first opening for relaying the developer from the first chamber into the second chamber and a second opening for relaying back, the partition partitioning between the chambers; a first feeder in the first chamber to feed the developer from the second opening toward the first opening; a second feeder the second chamber to feed the developer in the second chamber from the first opening toward the second opening; a first regulating portion above the second feeder, extended in a direction crossing with the second feeder to regulate movement of the developer fed by the second feeder; and a second regulating portion provided above the second feeder upstream of the first regulating member, extended in a direction crossing with the second feeder to regulate movement of the developer fed by second feeder.

### FIELD OF THE INVENTION AND RELATED ART

The present invention relates to developing devices to be employed by image forming apparatuses which use an electrophotographic, electrostatic, or the like recording method.

An image forming apparatus which uses an electrophotographic, electrostatic, or the like recording method forms a latent image on its image bearing member such as a photosensitive drum. Thus, it is equipped with a developing device which develops a latent image with the use of toner. Ordinarily, the interior of the housing (container) of a developing device is partitioned by a partitioning member, being therefore provided with two or more chambers through which developer, which contains toner, is conveyed by conveying members such as screws so that the developer is circularly moved through the housing. Further, a developing device is provided with a developer bearing member, such as a development sleeve, disposed next to an opening with which the housing is provided. Thus, the toner in the developer in a developing device is supplied to the developer bearing member through the opening.

Japanese Laid-open Patent Application No. 2004-205706 discloses a developing device provided with a development chamber and a stirring chamber created by partitioning the interior of the housing of the developing device with a partition wall (partitioning member). In the case of this developing device, developer is supplied to the development sleeve from the development chamber, and the developer used for development is recovered into the stirring chamber. The development chamber and stirring chamber are stacked in parallel, with the development chamber disposed under the stirring chamber. Further, as the developer is conveyed through the development chamber, the developer is pushed up into the stirring chamber by the pressure generated by the rotation of the developer conveyance screw disposed in the development chamber.

There is disclosed in Japanese Laid-open Patent Application No. 2010-186099, a developing device structured so that when it is brand-new, the initial supply of developer is kept sealed in its stirring chamber by a sealing sheet adhered to the edge of the opening of the partitioning wall between the development chamber and stirring chamber. In the case of this developing device, the downstream end portion of the stirring chamber is provided with an opening through which the excessive amount of the developer in the developing device is discharged from the developing device housing. Thus, it is provided with a regulating plate for regulating in height the body of developer in stirring chamber, on the upstream side of the developer discharge opening, in order to prevent the developer from excessively collecting in the adjacencies of the developer discharge opening, and being thereby discharged through the discharge opening by an excessive amount.

In the case of a developing device of the so-called function-separation type, such as the one disclosed in Japanese Laid-open Patent Application No. 2004-205706, which is provided with two chambers different in function, more specifically, a development chamber in which developer is supplied to the developer bearing member (first chamber), and a stirring chamber (second chamber) into which developer is recovered from the developer bearing member, the developer recovered from the developer bearing member continuously adds to the developer in the stirring chamber, which is being conveyed through the stirring chamber. Thus, in the stirring chamber, it is likely that the more downstream it is in terms of the developer conveyance direction, the higher the top surface of the body of developer. This creates a problem. That is, the higher the top surface of the body of developer, the greater the pressure to which the particles in the body of developer are subjected. The greater the pressure to which the particles in the body of developer are subjected, the greater the amount of friction to which the particles, of which the developer is made up, are subjected, and therefore, the more likely it is for the developer to deteriorate. Further, in the case of a developing device of the so-called function-separation type, the opening of the development chamber in which the development sleeve is disposed, and the stirring chamber, are directly connected through the developer recovery passage. Thus, as the top surface of the body of developer in the stirring chamber becomes higher, it is possible that the developer will overflow from the housing.

As a means for preventing the problem that developer overflows from a developing device of the so-called function-separation type, or the like problem, it is possible to regulate in height the body of developer in the stirring chamber, with the use of a regulating plate such as the one disclosed in Japanese Laid-open Patent Application 2010-186099. However, the regulating plate disclosed in Japanese Laid-open Patent Application 2010-186099 is intended to prevent the developer in the developing device from being discharged by an excessive amount immediately after the sealing sheet is removed and the developer begins to be circulated. Thus, it is disposed higher than the level at which the top surface of the body of developer should be during an image forming operation. Thus, there has been desired a structural arrangement for a developing device, which can regulate the body of developer in a developing device of the so-called function-separation type, in the height of the top surface of the body of developer, during an image forming operation.

### SUMMARY OF THE INVENTION

Thus, the primary object of the present invention is to provided a developing device of the so-called function-separation type, which is capable of properly regulating in height the top surface of the body of developer therein.

According to an aspect of the present invention, there is provided a developing device comprising a rotatable developer carrying member configured to carry a developer; a first chamber configured to accommodate the developer to be supplied to said developer carrying member; a second chamber provided adjacent to said first chamber in a horizontal direction and configured to accommodate the developer collected from said first chamber and said developer carrying member; a partition provided with a first communication opening configured to relay the developer from said first chamber into said second chamber and a second communication opening configured to relay the developer from said second chamber into said first chamber, said partition being configured to partition between said first chamber and said second chamber and constituting a collection path for collecting the developer carried on said developer carrying member into said second chamber; a first feeding member provided in said first chamber and configured to feed the developer from said second communication opening toward said first communication opening; a second feeding member provided in said second chamber and configured to feed the developer in said second chamber from said first communication opening toward said second communication opening; a first regulating portion provided above said second feeding member adjacent to said second communication opening, extended in a direction crossing with said second feeding member and configured to regulate movement of the developer fed by said second feeding member; and a second regulating portion provided above said second feeding member upstream of said first regulating member with respect to a developer feeding direction of said second feeding member, extended in a direction crossing with said second feeding member and configured to regulate movement of the developer fed by second feeding member.

Further features of the present invention will become apparent from the following description of exemplary embodiments with reference to the attached drawings.

### BRIEF DESCRIPTION OF THE DRAWINGS

FIG. 1 is a schematic sectional view of a typical image forming apparatus to which the present invention is applicable, and shows the structure of the apparatus.

FIG. 2 is a schematic sectional view of the developing device shown in FIG. 1, at a vertical plane perpendicular to the lengthwise direction of the device.

Part (a) of FIG. 3 is a side view of the interior of the developing device, and part (b) of FIG. 3 is a top view of the developing device, in which the development sleeve and a part of the partitioning member are not shown.

FIG. 4 is a block diagram of the control system of the image forming apparatus.

FIG. 5 is a schematic sectional view of the developing device, at a vertical plane which is perpendicular to the lengthwise direction of the device.

FIG. 6 is a top view of the developing device after the removal of the top wall of the housing of the developing device.

FIG. 7 is a schematic drawing of the developing device in the first embodiment, and shows the positioning of the row of regulating plates in the device.

FIG. 8 is a graph which shows the results of the measurement of the height of the top surface of the body of developer in the stirring chamber, in the developing device in the first embodiment, and those in the comparative developing device.

FIG. 9 is a schematic drawing of the developing device in the second embodiment, and shows the positioning of the row of regulating plates in the device.

FIG. 10 is a graph which shows the results of the measurement of the height of the top surface of the body of developer in the stirring chamber in the second embodiment of the present invention, and those in the comparative developing device.

FIG. 11 is a top view of the interior of the developing device in the third embodiment, after the removal of the top wall of the housing of the device.

FIG. 12 is a schematic drawing of the developer discharging portion of the developing device in the third embodiment, and shows the structure of the developer discharging portion.

Part (a) of FIG. 13 is a perspective view of a combination of the partitioning plate and housing of the developing device before the attachment of the partitioning plate to the housing, and part (b) of FIG. 13 is a perspective view of the combination of the partitioning plate and housing after the attachment of the partitioning plate to the housing.

FIG. 14 is a sectional view of the developing device in the third embodiment, at a vertical plane perpendicular to the lengthwise direction of the device.

Part (a) of FIG. 15 is a perspective view of a combination of a row of regulating plates, and the partitioning plate, in the third embodiment, as seen from the stirring chamber side; part (b) of FIG. 15, a perspective view of the combination of a row of regulating plates, and the partitioning plate, in the third embodiment, as seen from the development chamber side; and part (c) of FIG. 15 is an enlargement of a part of part (b) of FIG. 15.

Part (a) of FIG. 16 is a sectional view of the regulating edge portion of the regulating plate in the third embodiment, and shows the shape of the cross-section of the regulating edge portion; and parts (b) and (c) of FIG. 16 are sectional view of the modified versions of the regulating edge portion.

Part (a) of FIG. 17 is a perspective view of a modified version of the combination of the row of regulating plates and the partitioning plate in the third embodiment, and part (b) of FIG. 17 is an enlargement of a part of part (a) of FIG. 17.

### DESCRIPTION OF THE EMBODIMENTS

### Embodiment 1

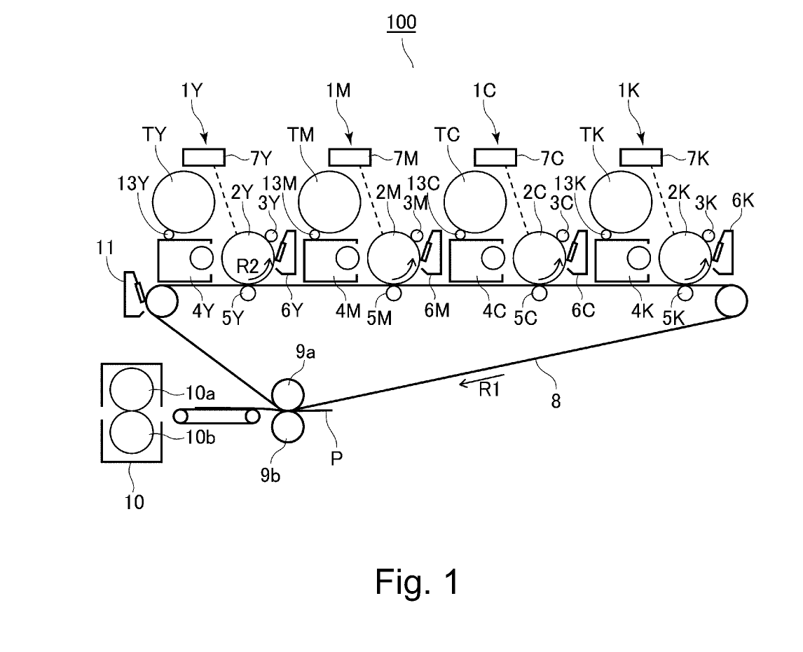

Next, the image forming apparatus 100 in the first embodiment is described with reference to appended drawings. The image forming apparatus 100 shown in FIG. 1 is a full-color printer of the so-called intermediary transfer type, and also, of the so-called tandem type. It has an intermediary transfer belt 8, and four image forming portions (drum cartridges) 1Y, 1M, 1C and 1K, which are disposed in tandem along the intermediary transfer belt 8.

### [Image Forming Portion]

The image forming portion 1Y, 1M, 1C and 1K are similar in structure although they are different in the color of the toner they use for development. Thus, their structure is described with reference to the image forming portion 1Y; the other image forming portions 1M, 1C and 1K are not described.

The image forming portion 1Y has a photosensitive drum 2Y. It has also a charge roller 3Y, an exposing device 7Y, a developing device 4Y, a primary transfer roller 5Y, a drum cleaning device 6Y, etc., which are disposed around the photosensitive drum 2Y. The photosensitive drum 2Y is an image bearing member which bears an electrostatic latent image, and a toner image. It is a photosensitive member which is in the form of a drum. It has a photosensitive layer which is the outermost portion of the photosensitive drum 2Y. It rotates at a preset process speed (peripheral velocity) in the direction indicated by an arrow mark R2. It is 30 mm, for example, in diameter, and 360 mm, for example, in dimension in terms of the direction parallel to its axial line. It rotates at a process speed of 250 mm/sec.

The charge roller 3Y is 14 mm, for example, in diameter, and 320 mm in dimension in terms of the direction parallel to its axial line. As preset charge bias voltage is applied to the charge roller 3Y, the charge roller 3Y uniformly charges the photosensitive drum 2Y to such polarity that is the same as the polarity to which toner is likely to become charged, and a preset potential level (pre-exposure level). The charge bias voltage is a combination of AC voltage which is −900 V, for example, in amplitude, and AC voltage which is 1500 V in peak-to-peak voltage. The exposing device 7Y writes an electrostatic latent image on the peripheral surface of the photosensitive drum 2Y by scanning the uniformly charged portion of the peripheral surface of the photosensitive drum 2Y with the beam L of laser light which it outputs while modulating the beam L according to the information about the image to be formed. The developing device 4Y contains two-component developer which is a combination of toner and carrier. It develops the electrostatic latent image into a toner image by supplying the peripheral surface of the photosensitive drum 2Y with the toner in the two-component developer.

The primary transfer roller 5Y is disposed so that it opposes the photosensitive drum 2Y with the intermediary transfer belt 8 being sandwiched between itself and the photosensitive drum 2Y. The image formed on the photosensitive drum 2Y is transferred (primary transfer) onto the intermediary transfer belt 8 by the bias voltage applied to the primary transfer roller 5Y. The toner remaining on the peripheral surface of the photosensitive drum 2Y after the primary transfer is removed by the drum cleaning device 6Y.

The intermediary transfer belt 8, which is an intermediary transferring member, is suspended by the primary transfer rollers 5Y, 5M, 5C and 5K of the image forming portions 1Y, 1M, 10 and 1K, respectively, and a roller 9a disposed on the inward side of the loop which the intermediary transfer belt 8 forms. It rotationally moves in the same direction (arrow mark R1) as the peripheral surface of the photosensitive drum 2Y, at the same speed as the peripheral surface of the photosensitive drum 2Y. The process through which the image forming portion forms a toner image (image forming operation) is synchronously carried out in all of the image forming portions 1Y, 1M, 1C and 1K. Then, the four toner images, different in color, formed in the four image forming portions, one for one, are sequentially transferred in layers onto the intermediary transfer belt 8. Consequently, a full-color toner image is effected on the intermediary transfer belt 8. Then, the full-color toner image is conveyed by the intermediary transfer belt 8 to the secondary transferring portion formed by the secondary transfer roller 9b, which is on the outward side of the intermediary transfer belt loop. Then, the toner images, of which the full-color image is made up, are transferred together (secondary transfer) onto a sheet of recording medium (ordinary paper, film for OHP, etc.). The toner remaining on the intermediary transfer belt 8 after the secondary transfer is removed by the belt cleaning device 11.

After the transfer of the toner images onto a sheet P of recording medium, the sheet P is heated and pressed in a fixing device which has a fixation roller 10a and a fixation roller 10b. Consequently, the toner is melted, and becomes fixed to the sheet P as it cools down. After being conveyed through the fixing device 10, the sheet P is discharged from the image forming apparatus 100 by an unshown sheet discharging mechanism.

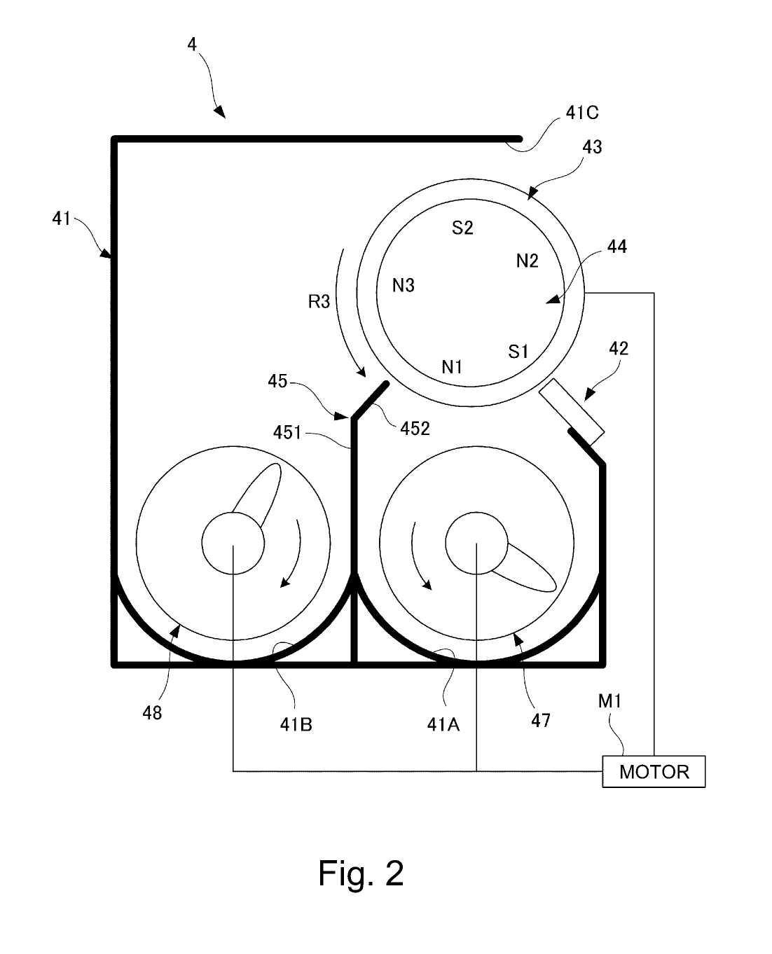

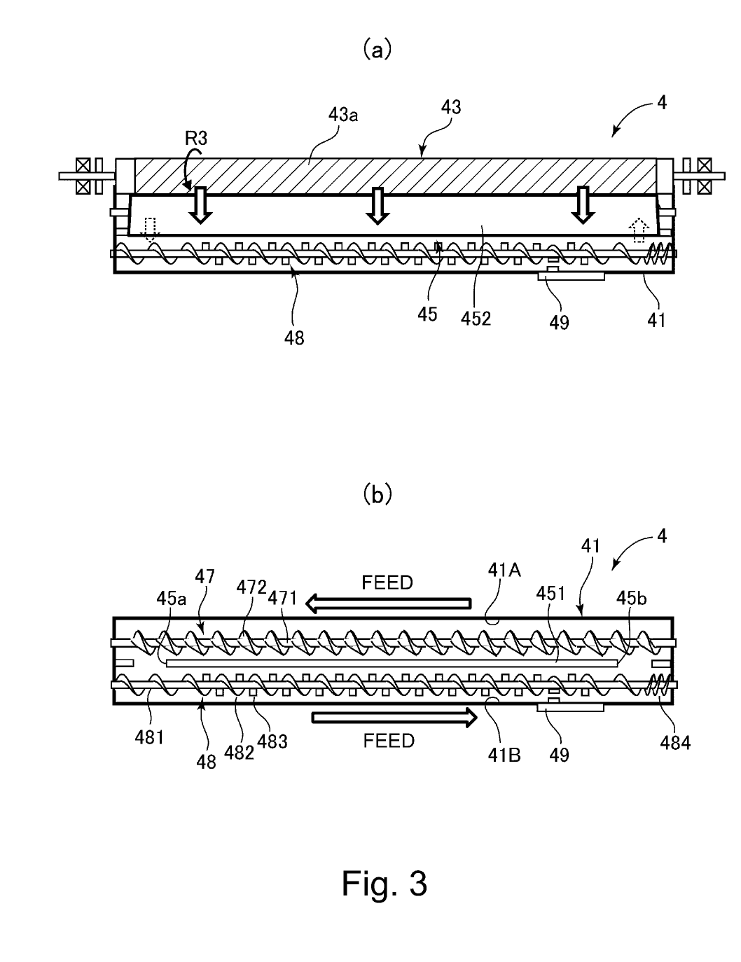

Next, referring to FIGS. 2 and 3, the developing devices 4Y, 4M, 4C and 4K of the image forming portions 1Y, 1M, 10 and 1K, respectively, are described. However, the developing devices 4Y, 4M, 4C and 4K are the same in structure although they are different in the developer they use. Hereafter, therefore, they are described as a developing device 4, which is usable as any of the four developing devices 4Y, 4M, 4C and 4K.

The developing device 4 uses two-component developer which contains nonmagnetic toner and magnetic carrier. Nonmagnetic toner is made by mixing coloring agent, wax, etc., into a resinous substance such as polyester and styrene acrylic, drying the mixture, and pulverizing the dried mixture into powdery substance (toner), or by polymerization. It contains microscopic particles of titanium oxide, silica, or the like, which cover the surface of a toner particle. Magnetic carrier is made up of particles made by pulverizing a hardened mixture of a resinous substance and magnetic particles such as ferrite particles. Magnetic carrier particles are coated with a resinous substance. When the developer is in the initial state, the toner density (weight ratio of toner in developer relative to entirety of developer) of the developer in the developing device is 8%. By the way, that developer is in the initial state means that the developing device 4 is brand-new when it is shipped out of a manufacturing facility, or when a drum cartridge is replaced.

Referring to FIG. 2, the developing device 4 has a housing 41, a development sleeve 43, a magnet 44, a blade 42, the first screw 47, and the second screw 48. The housing 41 in which developer is stored has an opening which faces the photosensitive drum 2Y. The development sleeve 43 is disposed in the housing 41 so that it is partially exposed through the opening. The housing 41 is shaped so that its lengthwise direction is parallel to the rotational axis of the development sleeve 43. Hereafter, therefore, the direction parallel to the axial line of the development sleeve 43 may be referred to as the lengthwise direction of the developing device 4.

The development sleeve 43 is a developer bearing member which rotates while bearing developer. It is cylindrical, and is formed of a nonmagnetic substance. It is 20 mm, for example, in diameter, and 334 mm, for example, in the dimension in terms of the direction parallel to its axial line. It is supported by the housing 41 in such a manner that it fits around the magnet 44, as a magnetic field generating means, fixed to the housing 41. It is rotatable at such a speed that matches the process speed (peripheral velocity of 250 mm/sec, for example).

The development sleeve 43 rotates in the direction indicated by an arrow mark R3 while bearing the developer adhered to its peripheral surface by the magnetic field generated by the magnetic pole S1 (attraction pole) of the magnet 44. As the development sleeve 43 rotates, the developer layer on the peripheral surface of the development sleeve 43 is regulated in thickness by the blade 42. The portion of the developer layer on the development sleeve 43, which has just been regulated in thickness, is conveyed to the development area where the development sleeve 43 faces the photosensitive drum 2Y. In the development area, the developer layer is made to form a magnetic brush by the magnetic field which a magnetic pole N2 (development pole) generates. The toner in the magnetic brush is made to transfer onto the peripheral surface of the photosensitive drum 2Y by the bias voltage applied to the development sleeve 43, in the pattern of distribution of the potential on the peripheral surface of the photosensitive drum 2Y. Consequently, the electrostatic latent image on the photosensitive drum 2Y is developed into a toner image. After the developer on the development sleeve 43 is used for the development, it separates from the development sleeve 43 while it is conveyed through the nonmagnetic area which a combination of magnetic poles N1 and N3 (separation pole) creates. Then, it is guided by a guiding portion 452 (which will be described later) to be recovered into the stirring chamber 41B.

In the housing 41, a partition plate 45 is disposed as a member for partitioning the internal space of the housing 41 into the development chamber 41A and stirring chamber 41B. Referring to parts (a) and (b) of FIG. 3, the development chamber 41A as the first chamber, and the stirring chamber 41B as the second chamber, are in parallel to each other, and their lengthwise direction is parallel to the axial line of the development sleeve 43. In terms of the direction parallel to the axial line of the development sleeve 43, one (left end in part (b) of FIG. 3) of the end portions of partition plate 45 is provided with the first passage 45a, through which developer is transferred from the development chamber 41A to the stirring chamber 41B, whereas the other end (right end in part (b) of FIG. 3) portion is provided with the second passage 45b, through which developer is transferred from the stirring chamber 41B to the development chamber 41A. That is, the development chamber 41A and stirring chamber 41B which are in connection to each other through the first and second passages 45a and 45b make up a circulatory passage through which developer is circulated in the housing 41.

In the development chamber 41A, the first screw 47 is disposed as the first conveying member for conveying developer, whereas in the stirring chamber 41B, the second screw is disposed as the second conveying member for conveying developer while stirring the developer. The first and second screws 47 and 48 have shaft portions 471 and 481, spiral conveyance fins (blade portions) 472 and 482, respectively, which are on the peripheral surfaces of the shaft portions. They are disposed in parallel so that their lengthwise direction is parallel to the lengthwise direction of the developing device 4 (housing 41). Further, the second screw 48 is provided with multiple stirring ribs 483 for increasing the second screw 48 in stirring efficiency. The stirring ribs 483 are positioned so that each fin 482 is between the adjacent two section of the spiral fin 472.

By the way, in the following, it is assumed that the first and second screws 47 and 48 are disposed so that they are roughly in parallel to each other, and level with each other, as seen from the horizontal direction. However, they do not need to be disposed to be level with each other as described in the followings, as long as they are disposed so that, as they are seen from the horizontal direction, they partially overlap with each other. Further, they may be disposed so that, as they are seen from the vertical direction, they are parallel to each other, but, as they are seen from the horizontal direction, the shafts of the two screws are tilted relative to each other.

The development sleeve 43, first screw 47, and second screw 48 rotate in synchronism by being driven by a development motor M1 (FIG. 2). Referring to FIG. 3, the first screw 47 conveys the developer in the development chamber 41A in one direction (leftward in drawing) of its shaft, whereas the second screw 48 conveys the developer in the stirring chamber 41B in the other direction (rightward in drawing). Thus, while the developer is conveyed by the development sleeve 43, the developer in the housing 41 is circulated within the housing 41.

### [Developer Recovery Passage]

Next, the structural arrangement for recovering the developer on the development sleeve 43 back into the stirring chamber 41B is described. Referring to FIG. 2, the partition plate 45 has: a partitioning portion 451 supported by the bottom portion of the housing 41; and a guiding portion 452 supported by the partitioning portion 451. The partitioning portion 451 roughly divides the internal space of the housing 41 into two sections, that is, the development chamber 41A and stirring chamber 41B between itself and the internal wall of the housing 41, with the presence of the first and second screws 47 and 48 in the development chamber 41A and stirring chamber 41B, respectively, creating thereby a circulatory developer conveyance passage in the housing 41. As for the guiding portion 452, it is in the form of a rectangular plate, and extends diagonally upward from the top end (edge) of the partitioning portion 451 toward the development sleeve 43 which is above the first screw 47.

Next, referring to part (a) of FIG. 3, the dimension of the guiding portion 452 in terms of the shaft direction is made to be long enough for the guiding portion 452 to cover the entirety of the area 43a of the peripheral surface of the development sleeve 43, which is to be coated with developer, that is, the developer bearing area, of the development sleeve 43. By the way, the “developer bearing area” means the area of the development sleeve 43, by which developer is reliably borne and conveyed. It is the area of the peripheral surface of the development sleeve 43, which has been microscopically abraded, for example.

As developer separates from the development sleeve 43, and falls, it is recovered into the stirring chamber 41B by sliding down (direction indicated by white arrow mark) on the slanted surface which the guiding portion 452 provides. That is, the partitioning plate 45 provides a recovery passage, through which the developer from the development sleeve 43 is recovered into the stirring chamber 41B, between itself and the top wall portion 41C (FIG. 2) of the housing 41. After being recovered into the stirring chamber 41B, the developer is conveyed, while being stirred, in the stirring chamber 41B along with the developer returned from the development chamber 41A to the stirring chamber 41B through the first passage 45a. Thus, the developer in the stirring chamber 41B is made uniform in toner density, while the toner and carrier in the developer are frictionally charged to a satisfactory level. Then, the developer is sent into the development chamber 41A through the second passage 45b.

[Structural Arrangement for Replenishing Developing Device with Developer]

Next, the structural arrangement for replenishing the developing device 4 with a fresh supply of developer is described. Referring to FIG. 1, the image forming apparatus 100 is provided with four replenishment tanks TY, TM, TC and TK, and four hoppers 13Y, 13M, 13C and 13K, which correspond to the image forming portions 1Y, 1M, 10 and 1K, respectively. The replenishment tanks TY-TK store replenishment developers, which contain yellow, magenta, cyan and black toners, which correspond to the image forming portions 1Y, 1M, 1C and 1K, respectively. They are removably mountable on the main assembly of the image forming apparatus 100. The replenishment developers in the replenishment tanks T are discharged into the corresponding hoppers 13, respectively, which are equipped with a replenishment screw capable of extruding developer into the stirring chamber 41B of the housing 41, by a preset amount per rotation, for example.

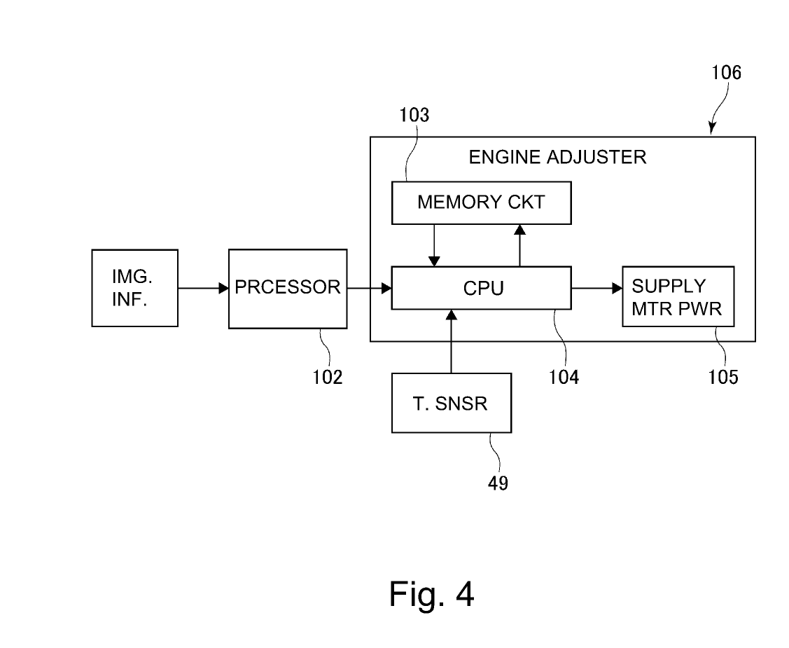

Referring to part (a) of FIG. 3, the housing 41 is provided with a density sensor 49 which detects the toner density of the developer in the housing 41. Next, referring to the block diagram in FIG. 4, the signals from the density sensor 49 are sent to an engine adjustment system 106 as a control portion which controls the operation of the image forming apparatus 100. The engine adjustment system 106 has: a CPU 104 which receives the information regarding the image to be formed by way of an image processing device 102; a storage circuit 103 in which the information regarding the settings of the image forming apparatus 100, and the like, is stored; etc. It controls the operation of the image forming apparatus 100, which includes the above-described image forming operation. As the CPU 104 determines, based on the signals from the above-described density sensor 49, that the developer in the housing 41 has reduced in toner density, it drives the hoppers 13Y, 13M, 13C and 13K with the use of a replenishment motor, by controlling a replenishment motor power source 105 as necessary. Thus, replenishment developer is supplied to the housing 41 by a necessary amount to keep the developer in the housing 41 roughly stable in toner density. By the way, the CPU 104 controls also the development sleeve 43, first screw 47, second screw 48 of the developing device 4 in rotational speed, by controlling the driving of the development motor M1 (FIG. 2).

### [Developer Overflow and Developer Deterioration]

At this time, the phenomena which occur to a conventionally structured developing device are described. Generally speaking, in the case of a developing device of the so-called function separation type, that is, a developing device like the above-described developing device 4 structured so that developer is supplied to the developer bearing member from the development chamber 41A (first chamber), and is recovered from the developer bearing member into the stirring chamber 41B (second chamber), the developer in the stirring chamber 41B is likely to be distributed in such a manner that the more downstream it is in the stirring chamber 41B in terms of the developer conveyance direction, the greater the amount of the developer, because while the developer in the stirring chamber 41B is conveyed by the second screw 48, the developer recovered from the development sleeve 43 continuously adds to the developer in the stirring chamber 41B.

Further, in the case of a developing device of the so-called function-separation type, the developer in the development chamber 41A is distributed in such a manner that the more downstream it is in terms of the developer conveyance direction, the smaller the amount of developer, because in the development chamber 41A, the developer is conveyed by the first screw 47 while the toner in the developer is continuously adhered to the development sleeve 43. If the top surface of the body of developer in the development chamber 41A becomes extremely low, it is possible that the amount by which the developer is borne by (coated on) the development sleeve 43 will become insufficient. Therefore, it is desired that a developing device is structured so that no less than a preset amount of developer is always kept in the adjacencies of the second passage 45b, in order to ensure that there remains a sufficient amount of developer in the adjacencies of the second passage 45b. For the reasons described above, in the stirring chamber 41B of a developing device of the so-called function-separation type, the more downstream it is in terms of the direction developer is conveyed by the second screw 48, the higher the top surface of the body of developer.

The higher the top surface of the body of developer, the higher the pressure to which the developer particles in the body of developer are subjected. If a body of developer is subjected to an excessive amount of pressure, microscopic particles of titanium oxide, silica, and the like, adhered to the surface of a toner particle which is made of a resinous substance, will be separated from the toner particle, or embedded into the toner particle, causing the microscopic particles to reduce in their effectiveness in their ability (spacer effect) of improving the toner in fluidity by preventing toner particles from adhering to each other, allowing thereby developer to reduce in fluidity. Further, the resinous coat on the surface of a carrier particle is frictionally worn. As the resinous coat on the surface of a carrier particle is worn, the carrier reduces in its ability to frictionally charge the toner, making it possible that an image forming apparatus will become unstable in image density. That is, as the pressure to which developer is subjected increases, developer sometime deteriorates sooner than expected.

Further, as the top surface of the body of developer in the stirring chamber 41B becomes higher, it is possible that the developer will overflow from the housing 41, and contaminate the interior of the image forming apparatus 100, because in the case of a developing device of the so-called function-separation type, the stirring chamber 41B is directly in connection to the outside of the housing 41 through the developer recovery passage. That is, in the case of a conventionally structured developing device of the so-called function-separation type, it is possible that the top surface of the body of developer in the stirring chamber 41B will sometimes become high enough to cause such problems that the developer is made to deteriorate by the pressured to which it is subjected in the stirring chamber 41B, and/or the developer overflows from the stirring chamber 41B.

By the way, in the case of a developing device structured so that its development chamber and stirring chamber are vertically stacked in parallel, it is necessary for developer to be scooped upward from the bottom side of the partitioning member to the top side of the partitioning member, in order to circulate the developer in the developing device. Thus, in the area in which the developer is scooped up, while the developer is scooped up into the top side of the partitioning member from the bottom side of the partitioning member, the developer is subjected to such an amount of pressure that is large enough to push at least a part of the body of developer on the bottom side of the partitioning member above the partitioning member.

On the other hand, the first and second screws 47 and 48 are disposed so that they are parallel to each other as seen from the vertical direction, and partially overlap with each other as seen from the horizontal direction. Therefore, the developing device 4 in this embodiment is substantially smaller in the amount of stress to which developer is subjected when the developer is transferred between the development chamber and stirring chamber, than a developing device structured so that its development chamber and stirring chamber are vertically stacked. However, even though the developing device 4 in this embodiment is structured as described, it is desired, for the reasons described above, that the developing device can prevent the problem that the developer therein is made to deteriorate by the pressure to which it is subjected in the stirring chamber 41B.

### [Structural Arrangement for Controlling Developing Device in Height of Top Surface of Body of Developer in Developing Device]

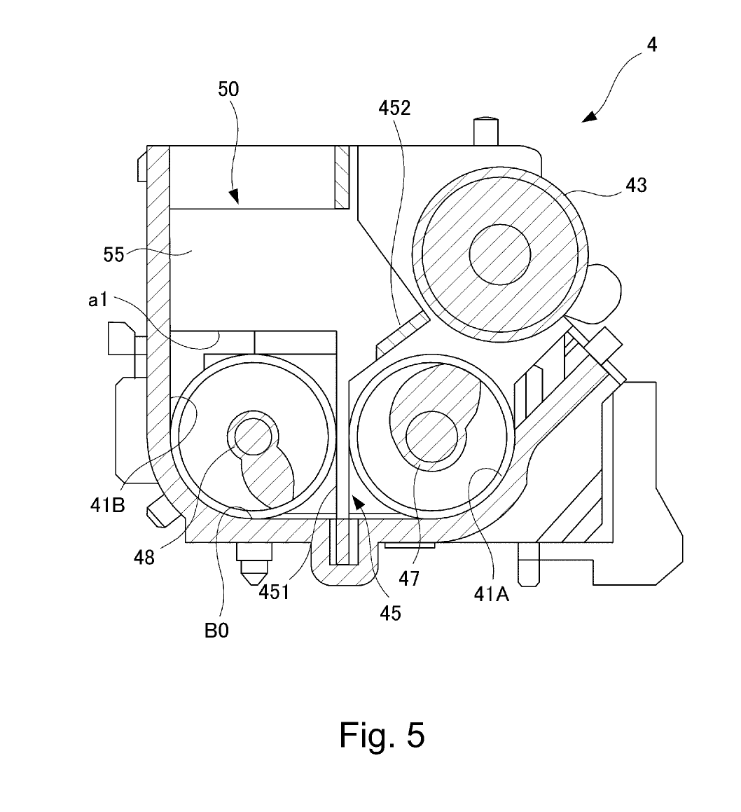

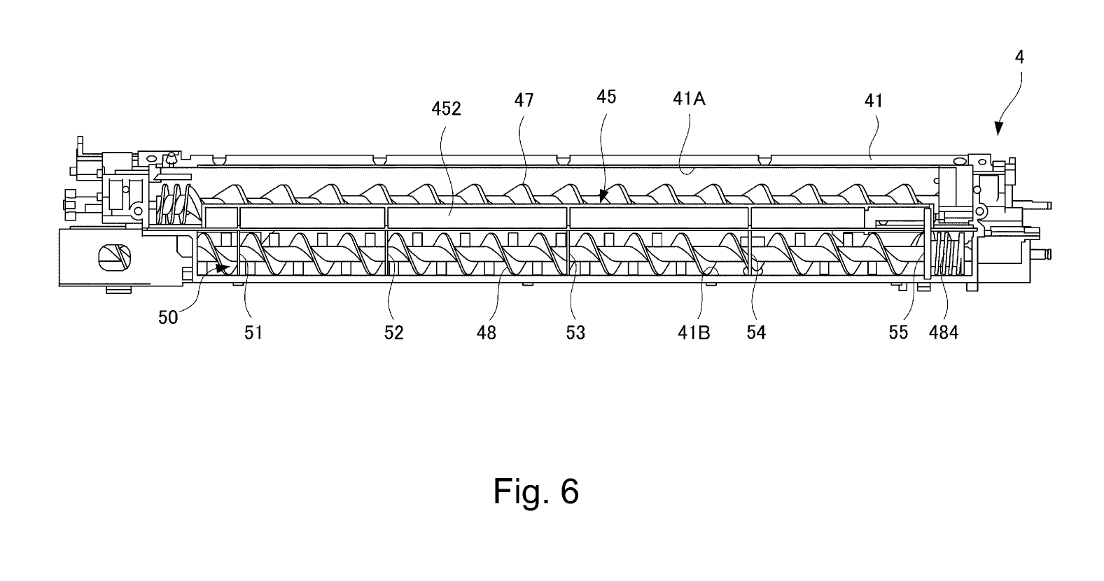

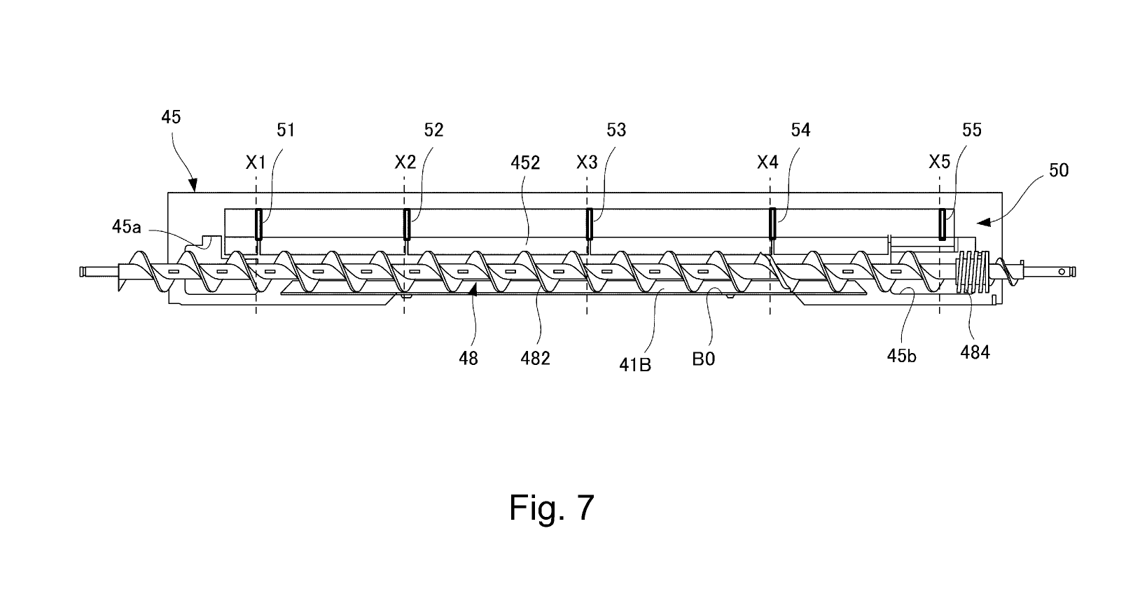

Therefore, the developing device 4 in this embodiment is provided with a row 50 of regulating plates, which is disposed in the developer conveyance passage in the stirring chamber 41B. Next, referring to FIGS. 5-7, the regulating member, that is, the row of regulating plates, is described about its structure and function. FIG. 5 is a sectional view of the developing device 4 at a vertical plane which coincides with the second passage 45b, as seen from the lengthwise direction. FIG. 6 is a top view of the developing device 4 minus the top wall portion 41C of the housing 41. FIG. 7 is a side view of the developing device 4 minus one of the lateral walls of the housing 41, as seen from the stirring chamber side.

Referring to FIGS. 5 and 6, the row 50 of regulating plates is made up of five regulating plates 51, 52, 53, 54 and 55 disposed above the second screw 48. Each of the regulating plates 51-55 is such a regulating member that can regulate the body of developer in the stirring chamber 41B in the position (height) of the top surface, at its location. That is, it is such a regulating plate that its bottom edge a1 (FIG. 5) holds a preset distance (height) from the bottom portion B0 of the stirring chamber 41B. However, the preset position (height) of the bottom edge a1 has such a value that can enable the regulating plate to regulate in vertical position (height) the top surface of the body of developer in the stirring chamber 41B while the developer is circulated in the housing 41. In this embodiment, the regulating plates 51-55 are the same in the height of their bottom edge a1.

Referring to FIG. 6, as seen from above, the regulating plates 51-55 are desired to extend in the direction which is inter-sectional, preferably, perpendicular, to the shaft direction of the second screw 48. They are supported by the partition plate 45, and one of the lateral walls of the housing 41, that is, one of the lateral walls of the stirring chamber 41B, by their lengthwise ends, one for one. Further, referring to FIG. 7, the regulating plates 51-55 of the row 50 of regulating plates are aligned in parallel in the conveyance direction of the second screw 48, with the presence of a preset amount of interval between the adjacent two. In particular, they are distributed so that regulating plates 51 and 52 are disposed on the upstream side of the midpoint between the first and second passages 45a and 45b in terms of the conveyance direction of the second screw 48, whereas the regulating plates 53, 54 and 55 are disposed on the downstream side of the midpoint. Further, the regulating plate 55, which is the most downstream one in terms of the conveyance direction of the second screw 48, is disposed on the downstream side of an area 43a (part (a) of FIG. 3) of the development sleeve 43, which is coated with the developer.

In this embodiment (embodiment 1) of the present invention, the row 50 of regulating plates was disposed as follows. The edge of the first passage 45a was used as a referential point (0 mm point). Then, the positions of the regulating plates 51, 52, 53, 54 and 55 were defined as points X1, X2, X3, X4 and X5, respectively. The distances of the points X1, X2, X3, X4 and X5 from the referential point (0 mm point) were set to 0, 70, 150, 230 and 270 (unit of measurement was millimeter), respectively. The height of the bottom edge a1 of each of the regulating plates 51-55 was set to 30 mm.

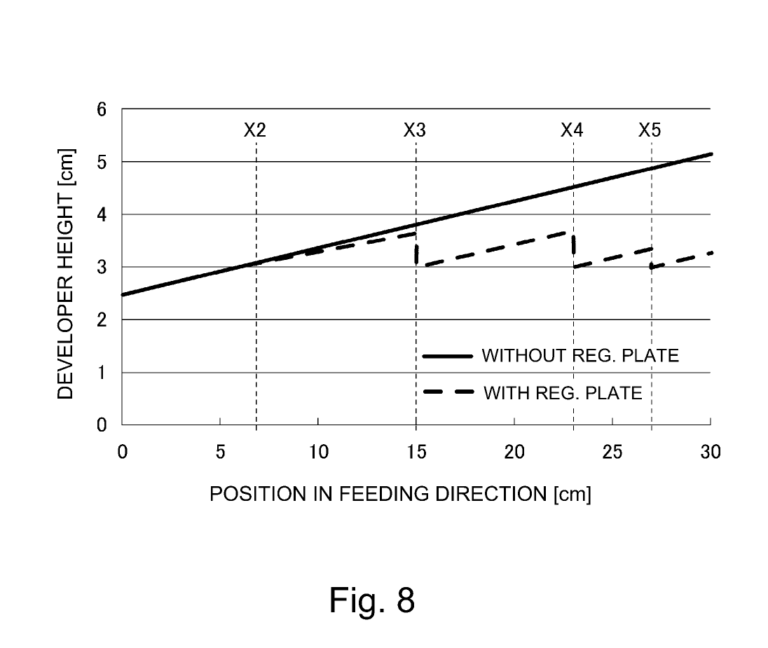

Next, the behavior of the body of developer in the developing device 4 in the first embodiment is described with reference to FIG. 8. The developing device 4 in the first embodiment was structured so that the amount by which developer was borne by (coated on) the developer bearing range of the development sleeve 43 was 40 mg/cm², and the development sleeve 42 was rotated at a peripheral velocity of 500 mm/sec. Further, the developing device 4 was structured so that the amount of the developer in the housing 41 became 240 g, and the first and second screws 47 and 48 were rotated at a rotational speed of 500 rpm.

The graph in FIG. 8 shows the results of the measurements of the height of the body of developer in the stirring chamber 41B in the developing device 4 in this embodiment, and those of the comparative developing device which was similar in structure as the one in the first embodiment, except that it did not have the row 50 of regulating plates. More concretely, the top wall portion 41C was removed from both the developing devices, and the height of the top surface of the body of developer in each developing device was measured from above while causing the developer in the device to circularly move in the device, by driving the development motor M1. The broken line represents the results of measurement for the developing device 4 in the first embodiment, which had the row 50 of regulating plates, whereas the solid line represents the results of measurement for the comparative developing device which did not have a row of regulating plates. By the way, the horizontal axis of the graph represents the distance from the edge (referential point: 0 cm) of the first passage 45a, like the positioning (distance) of each regulating plate of the row 50 of regulating plates.

In the case of the structural arrangement for the comparative developing device (solid line), developer was recovered into the stirring chamber 41B by way of the guiding portion 452 as described above. Thus, the more downstream it is in the stirring chamber 41B, the higher the top surface of the body of developer. In comparison, in the case of the structural arrangement for the developing device 4 in the first embodiment (broken line), the body of developer was compressed when it was conveyed past the points (X2, X3, X4 and X5) at which the regulating plates 52, 53, 54 and 55 were disposed, respectively, so that the top surface of the body of developer was pressed down to where the bottom edge a1 of each regulating plate was. That is, in the case of the structural arrangement for the developing device in this embodiment, the body of developer in the stirring chamber 41B was compressed by the multiple regulating plates 52, 53, 54 and 55. Therefore, the top surface of the body of developer in the stirring chamber 41B was kept lower than in the case of that for the comparative developing device.

By the way, while the developer in the developing device 4 is circulated through the developing device 4, the developer is stirred by the first and second screws 47 and 48. Therefore, the developer becomes greater in apparent volume (smaller in bulk density) than while it is left unstirred. While the developer in the developing device 4 in the first embodiment and that in the comparative developing device were left unstirred, both developers were roughly 1.7 g/cm³ in bulk density. However, while both developers were circulated, they were 0.8-1.1 g/cm³ in bulk density.

In the first embodiment, the height of the top wall portion 41C (FIG. 2) of the housing 41 from the bottom portion B0 of the stirring chamber 41B was set to roughly 500 mm. If the top surface of the body of developer in the stirring chamber 41B comes close to this critical height, the developer leaks out of the housing 41 through the gap (between main portion of housing and top wall portion of housing 41, for example) of the housing 41, or by flowing backward through the developer recovery passage. Further, the higher the top surface of the body of developer in the stirring chamber 41B becomes, the more likely it becomes for the developer particles to be kicked up by the second screw 48, and scatter out of the housing 41. These phenomena are likely to occur in the case of the structural arrangement for the comparative developing device. However, in the case of the structural arrangement for the developing device 4 in this embodiment, the occurrence of these phenomena is avoided.

### Effects of this Embodiment

In this embodiment, the row 50 of regulating plates is disposed in the developer conveyance passage in the stirring chamber 41B to press the body of developer in the stirring chamber 41B downward so that the top surface of the body of developer is lowered. Therefore, it was possible to properly control the body of developer in the position of its top surface, in spite of the fact that the developing device 4 was of the so-called function-separation type. Therefore, it was possible to avoid the occurrence of the problem that, because the position of the top surface of the body of developer in the stirring chamber 41B becomes extremely high, the developer overflows from the developing device 4. Further, the body of developer in the stirring chamber 41B was controlled so that the position of its top surface does not become extremely high. Therefore, it was possible to prevent the problem that the developer is deteriorated by the compressive force to which it is subjected.

By the way, it is desired that a developing device is structured so that the regulating plates are distributed as in the first embodiment. However, “to distribute the partitioning plates” does not mean “to evenly distribute the partitioning plates”. It means “to more or less randomly distribute them”. For example, all that is desired is that the partitioning plates are distributed in the shaft direction of the second screw 48 so that when the stirring chamber 41B is hypothetically divided into two or more sub-chambers, each sub-chamber is provided with at least one partitioning plate. Further, it is desired that the partitioning plates are distributed across the entirety of the stirring chamber 41B in terms of the developer conveyance direction as in the first embodiment.

Since the developing device 4 in this embodiment is structured as described above, it can more effectively prevent the developer overflow and/or developer deterioration than the conventional developing device structured so that the regulating member is disposed only in the adjacencies of the second passage 45b, for example. That is, in the stirring chamber (41B) of a developing device (4) of the so-called function-separation type, the more downstream it is in terms of the developer conveyance direction, the higher the position of the top surface of the body of developer. Thus, if the regulating member is disposed only in the adjacencies of the second passage 45b, the developer in the stirring chamber 41B collects on the upstream side of the regulating member. Therefore, it is possible that the developer will overflow from the developing device and/or the developer will be deteriorated by the compressive force attributable to its own weight. In comparison, by distributing the partitioning plates as in this embodiment, it is possible to control the body of developer in the stirring chamber 41B in the position of its top surface several times while the body of developer is conveyed through the stirring chamber 41B. Therefore, it is possible to keep the body of developer in the stirring chamber 41B stable in the position of its top surface while preventing the developer from excessively collecting in the downstream end portion of the stirring chamber 41B.

Further, in this embodiment, the most downstream regulating plate 55 of the row 50 of regulating plates in terms of the conveyance direction of the second screw 48 is disposed on the downstream side of the developer bearing area 43a (area to be coated with developer) of the development sleeve 43. Therefore, it is possible to reduce the effect of the developer recovered from the development sleeve 43, upon the changes in the amount of the developer in the stirring chamber 41B. Therefore, it is possible to stabilize the body of developer in the stirring chamber 41B, in the height of its top surface, in the most downstream area of the stirring chamber 41B.

By the way, the number of the regulating plates of the row 50 of regulating plates is to be set in consideration of the amount of the stress to which the developer is subjected when the developer is conveyed past the regulating plates. That is, if the number of the regulating plates is very large (for example, twice the number of spirals of the second screw 48), the top portion of the developer passage in the stirring chamber 41B is practically blocked by the regulating plates, and therefore, the developer in the stirring chamber 41B is conveyed through a narrow and roughly cylindrical space (passage) which results in the stirring chamber 41B because of the presence of the regulating plates. Therefore, the body of developer is incessantly compressed by the regulating plates. Consequently, the developer is acceleratedly deteriorated. Thus, it is desired, in consideration of the balance between its beneficial effect of stabilizing in height the top surface of the body of developer in the stirring chamber 41B, and the above-described adverse effects, that the number of the regulating plates of the row 50 is limited to a relatively small one as in the first embodiment.

Further, it is not mandatory that the regulating plates are rectangular in cross-section at a plane perpendicular to the developer conveyance direction. For example, they may be such plates, the cross-section of which is in the form of a inverted triangle, that is, such a plate that narrows toward the bottom.

### Embodiment 2

Next, the developing device 402 in the second embodiment is described. The developing device 402 in this embodiment is different from the developing device 4 in the first embodiment in that the regulating plates of a row 60 of regulating plates of the developing device 402 are different in the vertical position. Otherwise, the developing device 402 is the same in structure as the developing device 4 in the first embodiment. Therefore, the elements of the developing device 402, which are the same in structure and/or function as the counterparts of the developing device 4 in the first embodiment are given the same referential codes as those for the counterparts, one for one, and are not described here.

Generally speaking, regarding the developer flow in the stirring chamber 41B of a developing device of the so-called function separation type, or the type having two chambers which are different in function, the more downstream it is in terms of the conveyance direction of the second screw 48, the greater in volume the developer flow is. Therefore, if a developing device is structured to dispose its multiple regulating plates so that their bottom edges are at the same height as in the first embodiment, the amount of stress to which developer is subjected when it is conveyed past a downstream plate is likely to be larger than that when it is conveyed past a upstream one.

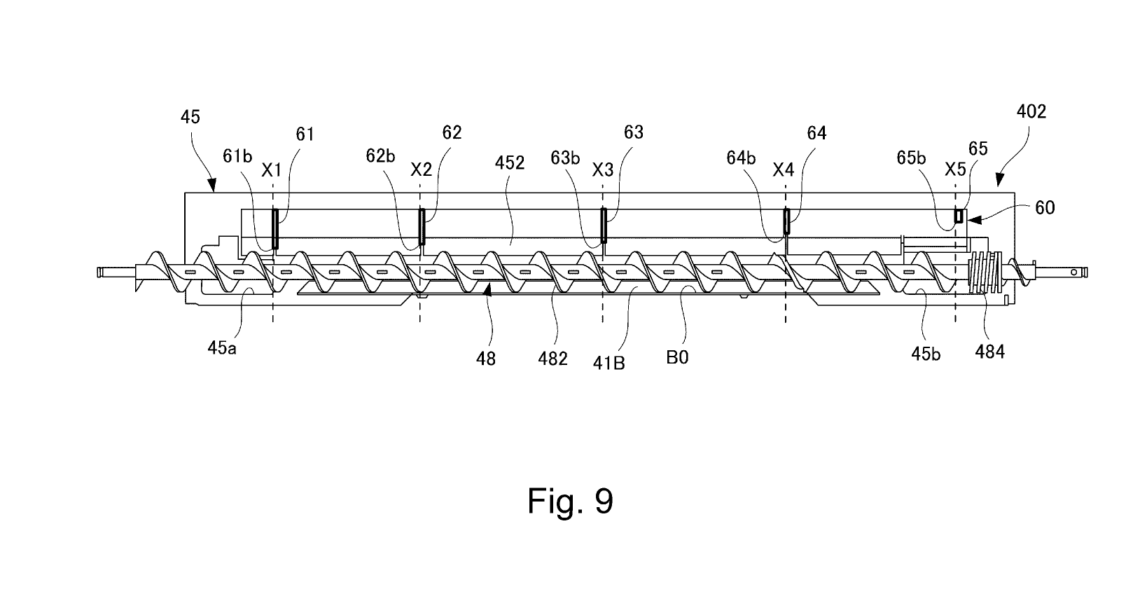

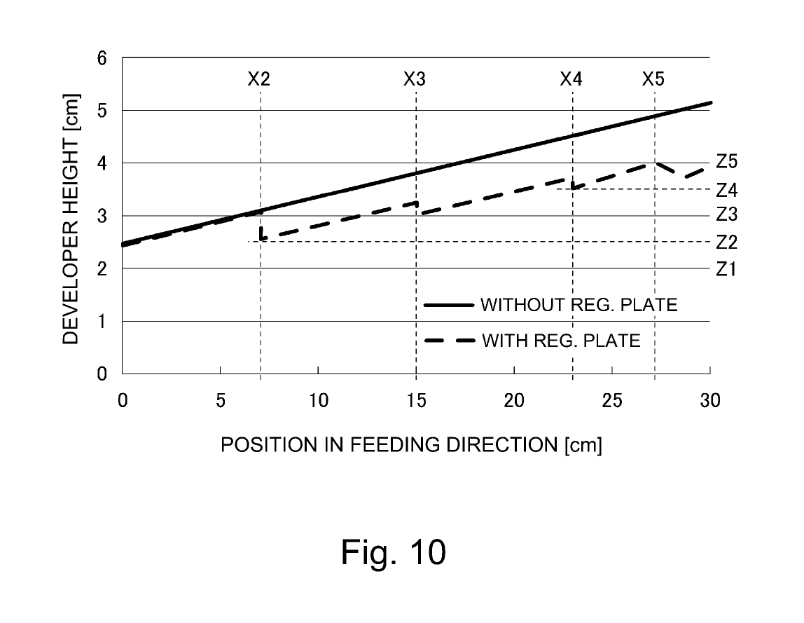

Referring to FIGS. 9 and 10, in this embodiment, therefore, the developing device 402 is structured so that its regulating plates 61, 62, 63, 64 and 65, as regulating members, listing from the upstream side in terms of the developer conveyance direction, are formed so that, in terms of the developer conveyance direction, the downstream one of any adjacent two regulating plates is simply higher in the position of its bottom edge than the upstream one. That is, the developing device 402 in this embodiment (second embodiment) was structured as follows. In FIG. 9, referential codes Z1, Z2, Z3, Z4 and Z5 stand for the heights of the bottom edges 61b, 62b, 63b, 64b and 65b of the regulating plates 61, 62, 63, 64 and 65, respectively, from the bottom portion B0 of the stirring chamber 41B. They are set to 20 mm, 25 mm, 30 mm, 35 mm and 40 mm, respectively. As for the positioning of the regulating plates of the row 60 of regulating plates in terms of the conveyance direction of the stirring chamber 41B, they are positioned in the same manner as those of the row 50 of regulating plates in the first embodiment.

Next, referring to FIG. 10, the developer behavior in the developing device 402 in the second embodiment is described. The graph in FIG. 10 shows the results of the measurements of the height (vertical position) of the top surface of the body of developer in the stirring chamber 41B in the developing device 402 in the second embodiment (broken line) and that in the comparative developing device (solid line) which is similar to the one compared to the developing device 4 in the first embodiment. The details of the method used for the measurement are the same as those of the one used for the developing device 4 in the first embodiment and the comparative one (FIG. 8).

Referring to FIG. 10, the body of developer in developing device 402 in the second embodiment was better controlled in the height of its top surface than in the body of developer in the comparative developing device which was not provided with regulating plates. That is, the second embodiment also was able to reduce the amount of developer overflow, and the amount of developer deterioration attributable to developer compression, like the first embodiment.

In addition, the developing device 402 in this embodiment was structured so that the regulating plates of the row 60 of regulating plates were formed and positioned so that, in terms of the developer conveyance direction, the downstream one of any adjacent two regulating plates is higher in the position of its bottom edge than the downstream one. In other words, the developing device 402 is structured so that a downstream regulating plate (regulating plate 64, for example) which is in the downstream portion of the stirring chamber 41B, which is greater in the volume of developer flow than the upstream portion, allows the developer passage to be greater (wider) in the cross-section which is perpendicular to the developer conveyance direction than the upstream one. Therefore, the amount of stress to which developer is subjected while it is conveyed under the regulating plates in the downstream portion of the stirring chamber 41B in this embodiment is significantly smaller than that in the first embodiment. Therefore, the developing device 402 in this embodiment is significantly smaller in the amount of developer deterioration attributable to developer compression than the developing device 4 in the first embodiment. In particular, in this embodiment, the body of developer in the stirring chamber 41B is regulated in the height of its top surface by the regulating plates 61-65, which were formed and positioned so that the height of their bottom edges are proportional to the amount of developer flow at their position in terms of the developer flow direction. Therefore, it is possible to prevent developer from collecting in the upstream adjacencies of any specific regulating plate. Therefore, it is possible to more effectively prevent the developer overflow.

By the way, in this embodiment, the developing device 402 was simply structured so that, in terms of the developer conveyance direction, the more downstream it is in the stirring chamber 41B, the higher the position of the bottom edge of the regulating plate. However, the developing device 402 may be structured so that the upstream one of any adjacent two regulating plates is the same, or higher, in the position of its bottom edges than the other. For example, the developing device 402 may be structured so that the position of the bottom edge of the most downstream regulating plate 65 is higher than that of the regulating plate 64, which is in the immediate upstream adjacencies of the regulating plate 65. In essence, all that is necessary is that the developing device 402 is structured so that the aforementioned multiple regulating members include the first regulating member, and the second regulating member which is on the upstream side of the first regulating member, and the bottom edge portion of the first regulating member is positioned higher than that of the second regulating member.

### Embodiment 3

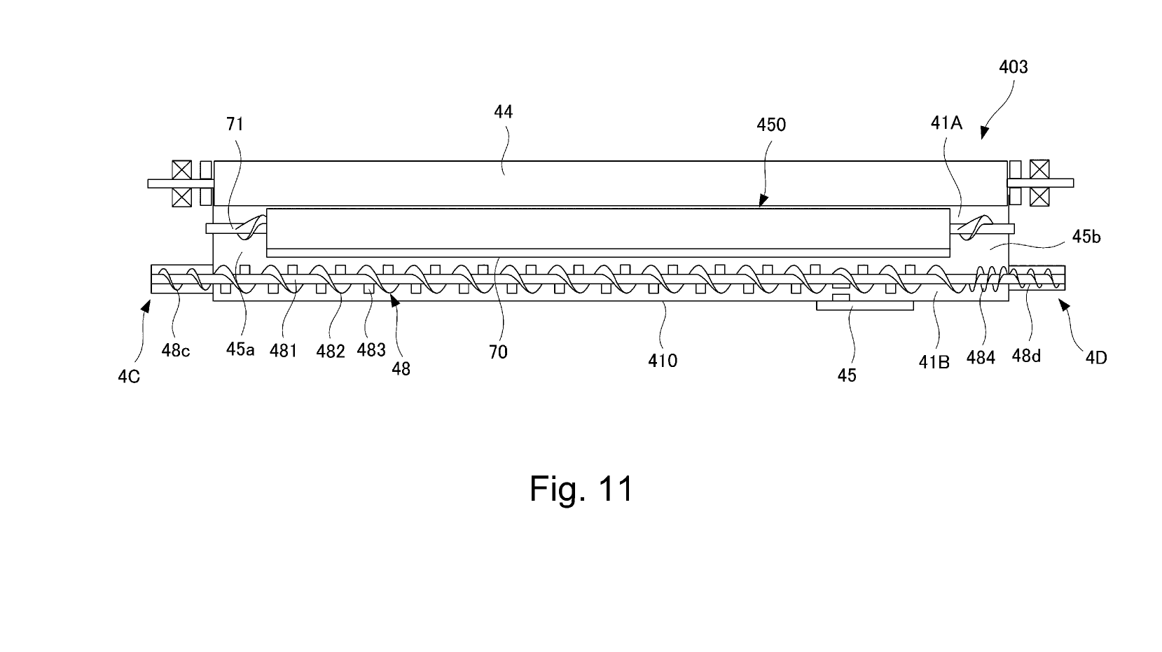

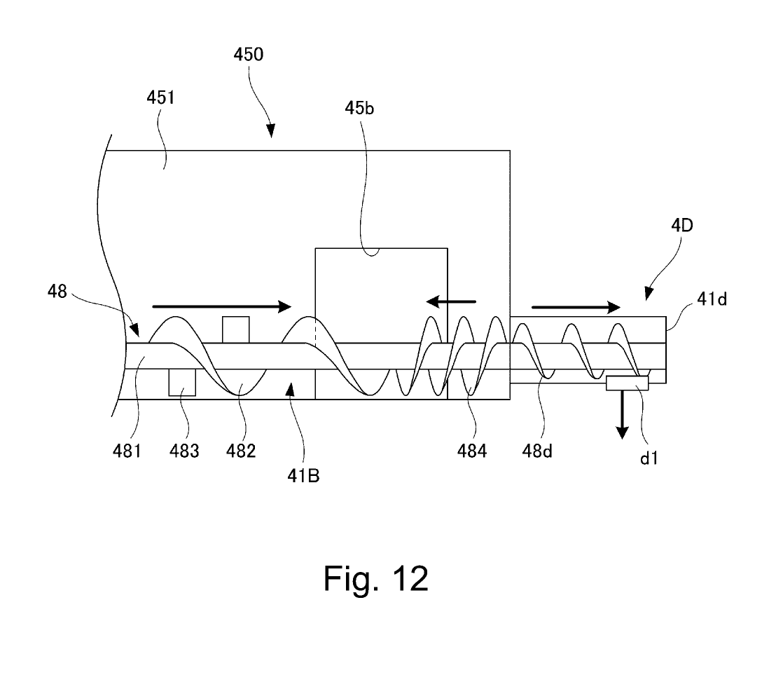

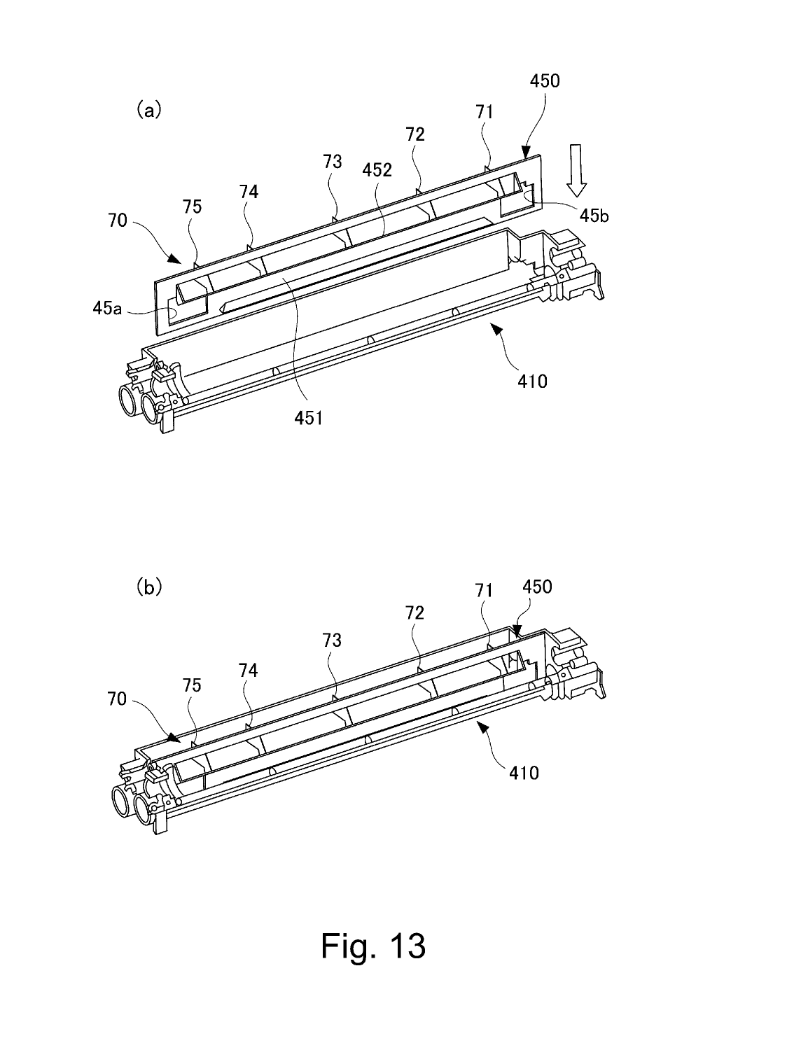

Next, referring to FIGS. 11-16, the developing device 403 in the third embodiment of the present invention is described. One of the characteristic features of the developing device 403 in this embodiment is that the regulating plates, which are regulating members, are used as structural members for increasing the developing device 403 in rigidity. Further, the developing device 403 in this embodiment is different from the developing device 4 in the first embodiment in that, in order to gradually replace one (carrier) of the components of the developer in the developing device 403, the developing device 403 is provided with a discharging portion 4D through which the developer is discharged. Next, the characteristic feature of the developing device 403 in this embodiment is described. The elements of the developing device 403 which are the same as the counterparts in the first embodiment are given the same referential codes as those given to the counterparts in the first embodiment, and are not described here.

Referring to FIG. 11, the developing device 403 is provided with a replenishing portion 4C for replenishing the housing 410 with a fresh supply of developer, and the discharging portion 4D for discharging developer from the housing 410. In terms of the conveyance direction of the second screw 48, the replenishing portion 4C is disposed on the upstream side of the stirring chamber 41B, whereas the discharging portion 4D is disposed on the downstream side of the stirring chamber 41B. The replenishing portion 4C is provided with a replenishment fin 48c, which is on the downstream side of the conveyance fin 482 of the second screw 48. It is replenished with replenishment developer from a replenishing device, and conveys the replenishment developer delivered from the replenishing device, to the stirring chamber 41B. By the way, the replenishing devices are the combinations of replenishment tanks TY, TM, TC and TK and hoppers 13Y, 13M, 13C and 13K, respectively.

### [Structural Arrangement for Discharging Developer]

Referring to FIG. 12, the discharging portion 4D has: a protrusive portion 41d which is protrusive downstream, in terms of the conveyance direction of the second screw 48, from the stirring chamber 41B; a return fin 484 attached to the shaft portion 481 of the second screw 48; and a discharge fin 48d attached also to the shaft portion 481 of the second screw 48. The bottom portion of the protrusive portion 41d is provided with a discharge opening d1. There is a spiral return fin 484, which is a portion for temporarily damming up developer flow, is in the immediate downstream adjacencies of the conveyance fin 482 in terms of the conveyance direction of the conveyance fin 482. It is opposite in the conveyance direction from the conveyance fin 482. The discharge fin 48d disposed in the protrusive portion 41d is also spiral, and is in the immediate downstream adjacencies of the return fin 484. It is the same in the direction of its spiral as the conveyance fin 482. By the way, the return fin 484 is made smaller in pitch than the conveyance fin 482, being thereby made higher in the efficiency with which it can transfer developer into the development chamber 41A by pushing back the developer as the developer is conveyed toward the return fin 484.

By the way, the replenishment developer which is to be delivered from the replenishing device contains toner and carrier at a preset ratio (9:1, for example). That is, it is a toner-rich developer. As an image forming operation is repeated, the toner in the developer is consumed. However, the carrier in the developer in a developing device 403 is returned to the housing 410. Thus, as the developing device 403 is replenished with the replenishment developer, the resultant increase in the amount of carrier in the housing 410 gradually increases the amount of developer in the housing 410. As the amount of developer in the housing 410 exceeds a threshold value which is determined by the external diameter of the above-described return fin 484, and the shape of the protrusive portion 41d, the developer in the housing 410 moves downward over the return fin 484 by an amount by which the amount of the developer in the housing 410 exceeds the threshold value, is discharged from the discharge opening d1 by the discharge fan 48d, and is recovered in an unshown recovery container by falling into the container.

As the replenishment developer is delivered to the housing 410, not only is the housing 410 replenished with toner by the amount equal to the amount by which the toner in the housing 410 was consumed, but also, a fresh supply of carrier is added to the housing 410. As the carrier in the developer in the housing 410 is repeatedly used for image formation, it gradually declines in charging performance. However, the excessive amount of developer in the housing 410, which includes the carrier which deteriorated with the elapse of time, is discharged through the discharge opening d1. Thus, the carrier in the housing 410 is gradually replaced. Therefore, it is possible to enable the carrier in the housing 410 to remain to be above no less than a preset level in charging performance. That is, this embodiment can improve an image forming apparatus in stability in terms of image quality.

By the way, this embodiment is not intended to limit the structure of the discharging portion 4D to the above-described one. For example, the housing 410 may be structured so that discharging portion 4D is provided with the discharge opening positioned higher than the top edge of a wall having a proper height to make the excessive amount of developer move over the wall to reach the discharge opening. In essence, all that is necessary is that the developing device 403 is provided with a damming portion which dams up the developer in the stirring chamber 41B as the developer is conveyed by the second screw 48 (second conveying member), so that only the developer having moved over the damming portion is discharged to keep the developing device 403 roughly stable in the amount of developer therein.

### [Structure of Regulating Plate and Structure of Partitioning Plate]

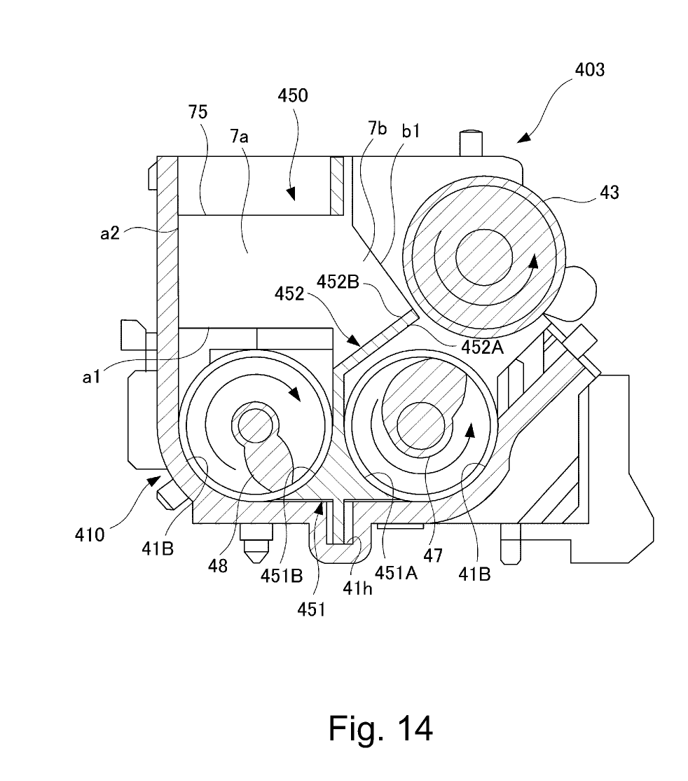

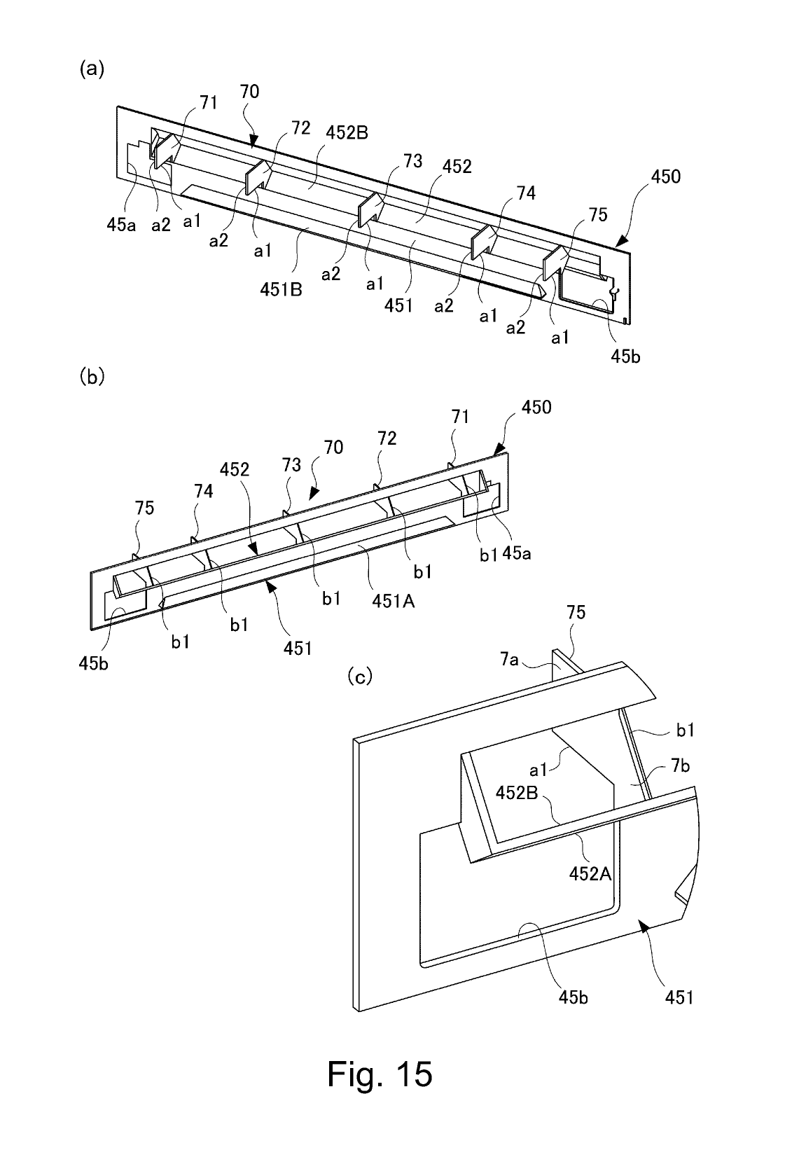

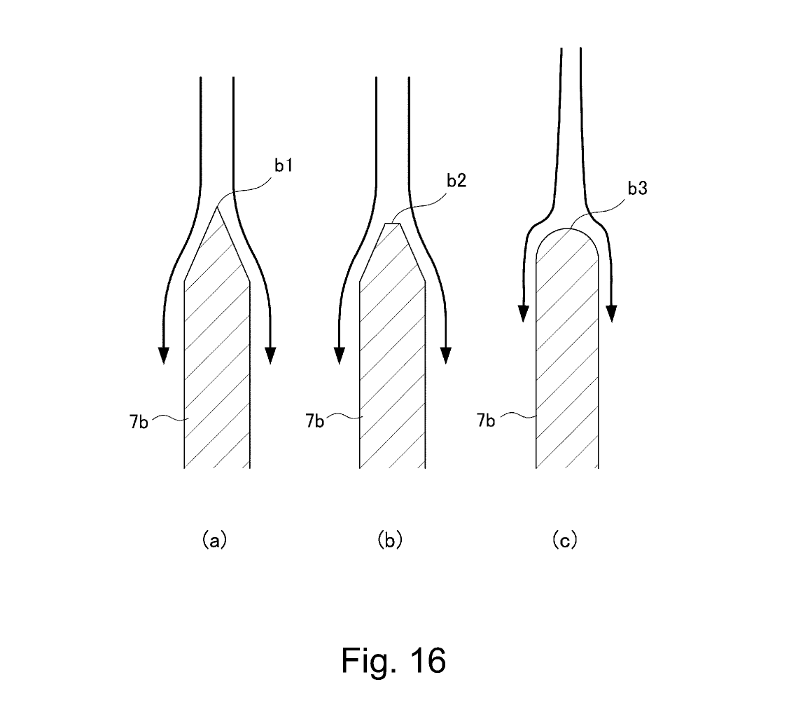

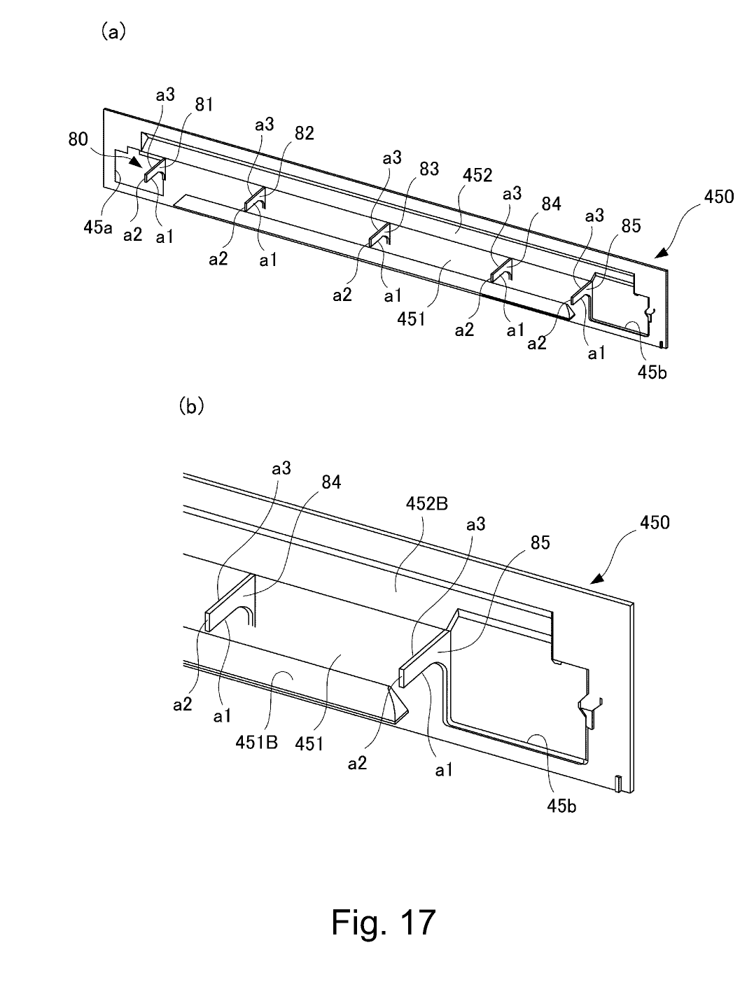

Next, a row 70 of regulating plates, and a partitioning plate 450, in this embodiment are described. Referring to parts (a) and (b) of FIG. 13, the row 70 of regulating plates, which is a regulating member made up of regulating plates 71, 72, 73, 74 and 74, is an integral part of the partitioning plate 450. The bottom portion of the housing 410 is provided with a holding portion 41h (FIG. 14), which is open upward. The partitioning plate 450, as a partitioning member, is held by the holding portion 41h by being inserted into the holding portion 41h from above the housing 410, with the top wall portion 41C (FIG. 2) of the housing 410 removed. Further, as it is inserted into the holding portion 41h, the row 70 of regulating plates comes into contact with the inward surface of the housing 410. This is how the partitioning plate 450 and row 70 of regulating plates are attached to the housing 410.

The positioning of the row 70 of regulating plates in terms of the conveyance direction of the second screw 48, and the function of the row 70 of regulating plates, which is related to the regulation of the top surface of the body of developer in the stirring chamber 41B, in this embodiment are the same as those in the first embodiment described above. That is, the regulating plates of the row 70 of regulating plates are distributed across the entirety of the stirring chamber 41B in terms of the conveyance direction of the second screw 48. Therefore, it is possible to properly regulate the body of developer in the stirring chamber 41B of the developing device 403, in the position of the top surface of the body of developer. Therefore, it is possible to prevent the developer from overflowing out of the developing device 403, and to minimize the developer deterioration attributable to developer compression.

Referring to part (a) of FIG. 14, the partitioning plate 450 has a partitioning wall portion 451 which keep the first and second screws 47 and 48 separated from each other, and a guiding portion 452 which extends diagonally upward from the top edge of the partitioning wall portion 451 toward the development sleeve 43 which is above the first screw 47. The guiding portion 452 extends in such a direction that its hypothetical extension will divide the peripheral surface of the development sleeve 43 into a portion which belong to the stirring chamber 41B and a portion which belongs to the development chamber 41A. Further, the guiding portion 452 is angled (greater than repose angle of developer, for example) so that as the developer on the peripheral surface of the development sleeve 43 separates from the development sleeve 43, it falls onto the top surface 452B of the guiding portion 452, and smoothly slides down on the top surface 452B toward the stirring chamber 41B.

Next, referring to FIGS. 14 and parts(a), (b) and (c) of FIG. 15, the bottom portion of the partitioning wall portion 451 is provided with a surface 451A which faces the first screw 47, and a surface 451B which faces the second screw 48. As seen from the direction which is parallel to the shafts of the first screw 47 and that of the second screw 48 are concavely arced so that the center of the curvature of the surface 451A coincides with the axial line of the second screw 48, and the center of the curvature of the surface 451B coincides with the axial line of the first screw 47. These surfaces 451A and 451B form, along with the portions of the inward surface of the housing 410, which also are concavely arced so that the center of their curvatures coincide with the axial line of the first screw 47 and that of the second screw 48, the developer passage in the development chamber 41A and that in the stirring chamber 41B, respectively.

Referring to FIG. 14 which shows the regulating plate 75, which is one of the regulating plates 71-75, each of the regulating plates 71-75 has a regulating portion 7a which is above the second screw 48, and a supporting portion 7b which supports the regulating portion 7a. The supporting portion 7b is perpendicularly attached to the top surface 452B of the guiding portion 452, and extends toward the stirring chamber 41B both in the upward and horizontal directions. The regulating portion 7a extends from the supporting portion 7b through the area which is above the second screw 48. It has the bottom portion a1 for regulating the developing device 403 in the position of the top surface of the body of developer in the stirring chamber 41B, and the side portion a2 which is in contact with the inward surface of the housing 410. That is, the developing device 403 is structured so that each of the regulating plates 71-75 is supported by the partitioning plate 450 by one end, whereas the other end is supported by the inward surface of the housing 410.

Referring to part (a) of FIG. 16, the edge b1 of the supporting portion 7b of each of the regulating plates 71-75, which is close to the development sleeve 43, is acutely angled toward the development sleeve 43 which is in the top portion of the drawing. That is, the developing device 403 is structured so that as developer separates from the development sleeve 43 and falls, it smoothly flows (indicated by downwardly pointed arrow marks), that is, without being interfered by the edge portion b1 of the supporting portion 7b. By the way, the edge portion b1 may be chamfered (b2) or given a smooth curvature (b3) as shown in parts (b) and (c) of FIG. 16, respectively, instead of being acutely angled. In essence, all that is necessary is that the edge portion b1 is shaped so that the closer it is to the development sleeve 43, the thinner the edge portion b1 (smaller in dimension in terms of direction parallel to axial line of development sleeve 43), in order to minimize the resistance it generates against the developer flow.

### [Pressure Applied to Partitioning Plate]

At this time, the phenomenon that, as developer is circulated through the developing device 403, such force that works in the direction to bend the partitioning plate 450 toward the stirring chamber 41B, is described. Referring to FIG. 14, the partitioning plate 450 faces the development chamber 41A by one side of the side surface of its partitioning wall portion 451 and the bottom surface 452A of its guiding portion 452, and faces the stirring chamber 41B by the other of the side surface of its partitioning wall portion 451. As the development motor M1 drives the developing device 403, the first screw 47 is rotated. Thus, the developer in the development chamber 41A is made to bump into the bottom surface 452A of the guiding portion 452 by the first screw 47. Therefore, while the developer is circulated in the development chamber 41A, the total amount of pressure which is applied to the partitioning plate 450 by the developer in the development chamber 41A is likely to exceed the total amount of pressure which is applied to the partitioning plate 450 by the developer in the stirring chamber 41B.

In addition, the difference between the first and second screws 47 and 48 in rotational direction, and the difference between the development chamber 41A and stirring chamber 41B in the amount of the developer therein, sometimes add to the force which presses the partitioning plate 450 toward the stirring chamber 41B. That is, as the first and second screws 47 and 48 rotate in the directions indicated in FIG. 14, the developer kicked up by the first screw 47 presses the partitioning plate 450 by directly bumping into the bottom surface 452A of the guiding portion 452. Further, sometimes, in order to ensure that the development sleeve 43 is reliably supplied with developer, no less than a preset amount of developer is kept in the development chamber 41A by making the amount by which developer is conveyable by the second screw 48 greater than that by the first screw 47. In a case where a developing device is structured in this manner, the top surface of the body of developer in the development chamber 41A becomes higher than that in the stirring chamber 41B, increasing thereby the force which presses the partitioning plate 450 toward the stirring chamber 41B.

If the partitioning plate 450 is bent toward the stirring chamber 41B (leftward in drawing), the clearance between the second screw 48 and partitioning wall portion 451 reduces. As the clearance reduces, the developer sandwiched between the conveyance fin 482 of the second screw 48 and the partitioning wall portion 451 is compressed by a substantial force, being therefore made to agglomerate. The agglomerated developer interferes with properly coating of the development sleeve 43 with developer, which possibly leads to the formation of unsatisfactory images. Further, it was possible that the interference between the second screw 48 and partitioning plate 450 would result in the generation of strange noises and/or destruction of the apparatus.

In particular, in this embodiment, the developing device 403 is structured so that the surface 451B, which is a part of the partitioning plate 450, faces the second screw 48, is given such a curvature that can form a developer passage, the cross-section of which matches the cross-section of the second screw 48, in coordination with the inward surface of the housing 410. Therefore, the developer in the stirring chamber 41B is efficiently stirred by the conveyance fin 482 of the second screw 48. However, this structural setup reduces the clearance between the second screw 48 and partitioning wall portion 451, and therefore, there was a concern that the developer would be made to agglomerate and/or the second screw 48 and partitioning wall portion 451 would interfere with each other.

Each of the regulating plates 71-75 of the row 70 of regulating plates extends in the direction which is perpendicular to the shaft direction of the second screw 48, and is supported by the guiding portion 452 by one end, whereas the other end is supported by the housing 410. Further, they are disposed so that they are distributed across the entire range of the stirring chamber 41B in terms of the developer conveyance direction in the stirring chamber 41B. That is, the developing device 403 is structured so that, with regard to the force directed from the development chamber 41A toward the stirring chamber 41B (leftward as well as up-and-leftward), the partitioning plate 450 is supported by the housing 410 with the presence of the row 70 of regulating plates between itself and housing 410. Therefore, even if the developer in the development chamber 41A happens to press the partitioning plate 450, the partitioning plate 450 is prevented from being deformed, because it is supported by the regulating plates 71-75. Therefore, a preset amount of clearance is maintained between the partitioning plate 450 and second screw 48.

By the way, in the case of a developing device of the so-called function separation type (double-chamber type), if the most downstream portion of the stirring chamber 41B is provided with the discharging portion 4D through which developer is discharged (FIG. 12), the top surface of the body of developer in the stirring chamber 41B becomes higher in the downstream portion of the stirring chamber 41B. Thus, it is possible that developer is discharged through the discharging portion 4D by an excessive amount. In comparison, in this embodiment, the body of developer in the stirring chamber 41B is regulated in the height of its top surface by the row 70 of regulating plates. Therefore, the top surface of the body of developer in the stirring chamber 41B remains stable in height in the adjacencies of the discharging portion 4D (in particular, in adjacencies of return fin 483). Therefore, it is unlikely for developer to be discharged through the discharging portion 4D by an excessive amount.

### [Modifications]

Next, referring to parts (a) and (b) of FIG. 17, one of the modified versions of the preceding embodiments are described. In the embodiments described above, the row 70 of regulating plates was supported by the guiding portion 452 of the partitioning plate 450. In this modified version of one of the preceding embodiment, a row 80 of regulating plates is supported by the partitioning wall portion 451 of the partitioning plate 450.

Referring to part (a) of FIG. 17, the row 80 of regulating plates is made up of regulating plates 81, 82, 83, 84 and 85, which are regulating members. Each of the regulating plates 81-85 is in the form a piece of plate, and extends from the partitioning wall portion 451, through the area above the second screw 48. It is an integral part of the partitioning plate 450. The regulating plates 81, 82, 83, 84 and 85 are distributed in the listed order, across the entire range of the stirring chamber 41B, in terms of the conveyance direction of the second screw 48.

Next, referring to part (b) of FIG. 17, each of the regulating plates 81-85 has: a bottom edge portion a1, which faces the second screw 48; a side edge portion a2, which is in contact with the inward surface of the housing 410; and a top edge portion a3, which extends roughly horizontally from the border between the partitioning wall portion 451 and guiding portion 452. Thus, if the developing device 403 is seen from the horizontal direction, the regulating plates 81˜85 are below the top surface 452B of the guiding portion 452. The top edge portion a3 is acutely pointed upward like the edge portion b1 in part (a) of FIG. 16.

Therefore, compared to a developing device structured so that a part of each regulating plate is above the top surface of the guiding portion like each of the regulating plates of the row 70 of regulating plates shown in part (a) of FIG. 15, this modified version of developing device can more reliably prevent the phenomenon that as developer separates from the development sleeve 43 and falls, its flow is interfered by the regulating plates. Further, the top edge portion a3 of each of the regulating plates 81-85 is acutely pointed. Therefore, it is smaller in the amount of friction (flow resistance) which it generates between itself and developer.

By the way, as long as the developing device 403 is structured so that its regulating plates are supported by the partitioning wall portion 451 of the partitioning plate 450, a part (side edge portion a2, for example) of each regulating plate may be positioned higher than the bottom edge portion of the guiding portion 452. Further, the shape of the top edge portion a3 does not need to be as described above. All that is necessary is that the top edge portion a3 is shaped so that its thickness (dimension in terms of direction of axial line of development sleeve 43) gradually reduces toward its tip.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-054706 filed on Mar. 18, 2016, which is hereby incorporated by reference herein in its entirety.

What is claimed is:

1. A developing device comprising:
a rotatable developer carrying member configured to carry a developer;
a first chamber configured to accommodate the developer to be supplied to said developer carrying member;
a second chamber provided adjacent to said first chamber in a horizontal direction and configured to accommodate the developer collected from said first chamber and said developer carrying member;
a partition provided with a first communication opening configured to relay the developer from said first chamber into said second chamber and a second communication opening configured to relay the developer from said second chamber into said first chamber, said partition being configured to partition between said first chamber and said second chamber and constituting a collection path for collecting the developer carried on said developer carrying member into said second chamber;
a first feeding member provided in said first chamber and configured to feed the developer from said second communication opening toward said first communication opening;
a second feeding member provided in said second chamber and configured to feed the developer in said second chamber from said first communication opening toward said second communication opening;
a first regulating portion provided above said second feeding member adjacent to said second communication opening, extended in a direction crossing with said second feeding member and configured to regulate movement of the developer fed by said second feeding member; and
a second regulating portion provided above said second feeding member upstream of said first regulating member with respect to a developer feeding direction of said second feeding member, extended in a direction crossing with said second feeding member and configured to regulate movement of the developer fed by second feeding member.

2. A device according to claim 1, wherein said second regulating portion is disposed upstream of an intermediate position between the first communication opening and said second communication opening with respect to the developer feeding direction of said second feeding member.

3. A device according to claim 1, wherein a gap is provided between a lower end of said first regulating portion and a bottom portion of said second chamber and is substantially the same as a gap provided between a lower end of said second regulating portion and a bottom portion of said second chamber.

4. A device according to claim 1, wherein a gap is provided between a lower end of said first regulating portion and a bottom portion of said second chamber and is larger than a gap provided between a lower end of said second regulating portion and a bottom portion of said second chamber.

5. A device according to claim 1, wherein said first regulating portion is disposed downstream of a carrying area where said developer carrying member carries the developer, with respect to the feeding direction.

6. A device according to claim 1, wherein a length of said first regulating portion measured in a direction perpendicular to the feeding direction is larger than a length of said second feeding member measured in the direction perpendicular to the feeding direction.

7. A device according to claim 1, wherein said developer carrying member is disposed above said first feeding member, and said separation member includes a partition wall portion supported by a bottom portion of said developing container and partitioning between said first feeding member and said second feeding member, and a guiding portion bent from an upper portion of said partition wall portion toward said developer carrying member to guide the developer removed from said developer carrying member toward said first chamber.

8. A device according to claim 7, wherein said first regulating portion and second regulating portion are supported by said partition, and said first regulating portion extends to said guiding portion.

9. A device according to claim 1, wherein said first regulating portion and second regulating portion are integral with said separation member.

10. A device according to claim 7, wherein said first regulating portion includes a plate-like member having a supporting portion provided on an upper surface of said guiding portion, and a contact portion contacting an inner wall of said developing container through an upper part of said second feeding member.

11. A device according to claim 9, wherein a width of at least a part of an end portion of said supporting portion measured in an axial direction of said developer carrying member decreases as approaching to said developer carrying member.
